(19) United States
(12) Patent Application Publication
(10) Pub. No.: US 2024/0057644 A1
(43) Pub. Date: Feb. 22, 2024

(54) COMBINATION AND DEVICE TO FACILITATE THAWING OF FROZEN FOOD ITEMS

(71) Applicant: ANDREW J. PARKER, EL PASO, TX (US)

(72) Inventor: ANDREW J. PARKER, EL PASO, TX (US)

(21) Appl. No.: 17/890,313

(22) Filed: Aug. 18, 2022

(51) Int. Cl. A23L 3/36; A23L 3/365

(52) U.S. Cl. CPC A23L 3/364; A23L 3/365

(57) ABSTRACT

A container or device in a combination for thawing frozen food items in a thawing process is described. It is at least partially filled with a fixed amount of water, with the food items in a leak-proof package completely submerged within the water. A housing of the device or container has slits that serve as inlets for the water to be drawn therein. A submersible pump within the housing agitates water from the container that is drawn in through the slits. An agitator outlet of the housing or container exhausts the water agitated by the pump into the container so as to be continuously circulated over the one or more frozen food items. This is done at specified water temperature and flowrate ranges such that no food items within the leak-proof package exceed 40° F. during the thawing process.

### CROSS-REFERENCE TO RELATED APPLICATIONS

The present application claims the benefit under 35 U.S.C. § 120 and is a continuation-in-part of U.S. patent application Ser. No. 15/790,030 to Andrew J. Parker (the “'030 application”), filed Oct. 22, 2017, pending. The entire contents of the '030 application is hereby incorporated by reference herein.

### BACKGROUND

### Field

The example embodiments in general are directed to a combination, and to a device that circulates water around frozen food items or other articles to facilitate thawing thereof.

### Related Art

Freezing is common and important for safe storage and convenient transport of food and other articles. The ability to safely thaw and/or defrost these items is important, particularly for uncooked meat, fish, and similar foods. This is because if these types of food items are thawed or defrosted too rapidly, the taste and texture thereof may be diminished. More importantly, if the temperature during thawing or defrosting of these types of items gets too warm, the risk of microbial growth and food poisoning can be markedly increased.

A food preparer who plans ahead can utilize the safest recommended method, thawing in a refrigerator. But as this takes many hours, typically overnight, thawing via refrigerator is impractical to deploy shortly before cooking. Applying heat or thawing in a microwave oven is not recommended, as the microwave energy and heat negatively affects the color, texture, and taste, and additionally risks raising the temperature of the food items into a range conducive to the growth of harmful bacteria.

Thawing may be safely accelerated by circulating the medium around the frozen food item or other article at a temperature slightly above the freezing temperature of water (32° F.). Conventional devices that circulate heated air for thawing, for example, are well-known in the art. The transfer of heat to a frozen food item or other article is further enhanced by employing a medium which has a greater density and capacity for heat transfer. As such, some conventional devices employ air with elevated humidity and controlled temperature to reduce the thawing time, which often includes some type of air circulation. A widely used, practical method is to immerse the article in running water, in a sink under an open tap. However, this wastes water and occupies the tap; as such a recirculation process may be more desirable.

Example devices employing a circulating water bath for thawing are plentiful in the prior art. Fuller et al. (U.S. Pat. No. 5,146,843) describe a thawing device which fills a container at a predetermined flow rate until it is high enough to drain into a second container, from which it is circulated back into the first container. Halterman et al. (U.S. Pat. No. 5,797,270) describe another chamber with refrigeration means in which the circulated water maintains a specific desired temperature, more specifically a sealable chamber which circulates water around frozen items using an automated “thawing cycle”. Similarly, Thompson (U.S. Pat. No. 6,691,608) describes a thawing device that more simply re-circulates water through two containers. Luketic et al. (US Patent Appl. Publ. US 2013/0323386) describe a commercial sink with an integrated water circulator.

These above-described conventional devices are expensive and large, making them practical only in commercial preparation areas that require regular, continuous operation. Also, many of the conventional devices have a fixed capacity to handle frozen articles, which may be insufficient for preparing a large meal. Else, these devices are too cumbersome or large when it is desired to conveniently thaw a few small food articles, and typically are extremely wasteful as to power consumption and water usage. Additionally, these conventional devices often incorporate one or more containers, which increases the difficulty to clean and sterilize if they should become contaminated.

Another conventional device is shown in FIG. 1; namely the figure illustrates a recirculating water defroster as described in U.S. Publ. Pat. Appl. No. 2015/0135974 to Ambrosi, et al. (“Ambrosi”). The Ambrosi device is specifically designed to defrost foot items without immersing the food item in water within a container, sink, and the like. As such, Ambrosi developed a system which is touted to defrost food efficiently, effectively, and also to conserve precious water resources. As shown in FIG. 1,

The Ambrosi recirculating water defroster includes a water pump 2 which is placed in a tub 14 of water, with a water pipe 6 extending upward from the water pump 2 into the ambient air above the water tub 14 so as to terminate in a spout 8, and a grate 10 situated above the tub 14 of water on which is placed the food 12. The water pipe 6 and spout 8 essentially form a water dispenser unit that dispenses water delivered from the water pump 2 up over and on top of the food 12 that resides within the ambient air and outside tube 14 on the grate 10, so as to provide a soaking shower onto the exposed food 12.

Tub 14 is shown as partially filled with water so that the water pump 2 is submerged and includes an inlet hole 4 for water intake, but the water level remains below the grate 10. In operation, water pump 2 takes in water through the inlet hole 4 and recirculates water through water pipe 6 up to spout 8. Water rains down on food 12, flows through grate 10, recollects in tub 114, and is taken up again by water pump 2 to be recirculated.

The Ambrosi recirculating water defroster has a number of limitations, apart from its substantial size and lack of compactness. With the food 2 sitting in ambient air and outside the water, there is little ability to control a constant temperature around the food item between the raining water and the temperature of the ambient air. There is no water circulation; this makes it ever so much more difficult to ensure the internal temperature of the food stays below a thawing temperature at or above which facilitates bacteria growth. This is not optimal for food safety. Moreover, the food 2 is exposed directly to the ambient air with no leak proof package or wrap around it, subject to direct exposure to airborne pathogens, bacteria, and the like.

Accordingly, what is needed is a device that circulates water around frozen food items or other articles to facilitate thawing thereof that is simple to use, compact in size, and portable so as to be easily adapted for placement into a kitchen sink, bowl or container with the frozen item therein to defrost the item within the sink, container within the sink, or within a container on a kitchen counter or other surface. Additionally, such as a device should be configured to circulate water within a specified temperature range using a pump flowrate within a specified flowrate range to optimize food safety per FDA guidelines. Moreover, there is desired a device that is placed in a fixed amount of water within a container so as to circulate that water around frozen food items, thereby conserving water usage.

### SUMMARY

An example embodiment of the present invention is directed to a combination. The combination includes a container at least partially filled with a fixed amount of water maintained in a specified temperature range, one or more frozen food items contained within a leak-proof package, the leak-proof package with one or more frozen food items completely submerged within the fixed amount of water in the container, and a device to facilitate thawing the one or more frozen food items in a thawing process in which the device is completely submerged within the fixed amount of water in the container. The device further includes a housing having a detachable bottom cover at a lower end of the housing. The detachable bottom cover has a flat bottom wall and vertical side walls, with upper ends of the vertical side walls in contact with the lower end of the housing, each of the vertical sidewalls and flat bottom wall of the detachable bottom cover including a plurality of spaced slits for ingress of the water in the container up through the slits in the detachable bottom cover and into the housing interior. The device includes a sealed, waterproof submersible water pump provided within the housing interior and directly accessible via removal of the detachable bottom cover, the submersible water pump adapted to agitate water from the container that is drawn in by the submersible water pump through the slits at a constant flowrate maintained within a specified flowrate range. The device includes an agitator outlet which remains completely submerged within the fixed amount of water in the container throughout the thawing process, the submerged agitator outlet extending outward from and perpendicular to a vertical side of the housing for exhausting the water agitated by the water pump directly back into the existing fixed amount of water within the container so as to be circulated over the one or more frozen food items within the leak-proof package.

Another example embodiment is directed to a device to facilitate thawing of one or more frozen food items contained within a leak-proof package that is completely submerged along with the device in a fixed amount of water within a container, the fixed amount of water maintained within a first temperature range during a thawing process and circulated by the device at a constant flowrate within a second flowrate range during the thawing process over the submerged leak-proof package containing the one or more frozen food items. The device includes a housing having a plurality of slits at a bottom end thereof, one or more suction elements arranged on a surface of the housing for securing the device fixedly in place to a surface of the container, and a sealed, waterproof submersible water pump provided in the housing and adapted to agitate water from the container that is drawn up through the slits and agitated across an interior bottom surface within the housing. The device includes an agitator outlet attached to the housing so as to remain completely submerged within the fixed amount of water in the container throughout the thawing process for exhausting the water agitated by the submersible water pump so as to be circulated over the leak-proof package containing the one or more frozen food items. The first temperature range is 35° F. to 42° F. during the thawing process, and the second flowrate range is a constant flowrate of 50 gallons per hour (GPH) to 90 GPH during the thawing process. The combination of maintaining the first temperature range and the second flowrate range of water over the completely submerged one or more food items within the leak-proof package during the thawing process prevents the one or more frozen food items within the leak-proof package from reaching an internal temperature in excess of 40° F.

Another example embodiment is directed to a combination, in which the combination comprises a container at least partially filled with a fixed amount of water maintained at a water temperature in a first range, one or more frozen food items contained within a leak-proof package, the leak-proof package with one or more frozen food items completely submerged within the fixed amount of water in the container, and a device to facilitate thawing the one or more frozen food items in a thawing process in which the device is completely submerged within the fixed amount of water in the container. The device includes a housing having a detachable bottom cover at a lower end of the housing for access to the interior of the housing, and a sealed, waterproof submersible water pump provided within the housing interior and directly accessible via removal of the detachable bottom cover, the submersible water pump adapted to agitate water from the container that is drawn in by the submersible water pump through the slits at a constant flowrate within a second flowrate range. The first temperature range is 35° F. to 42° F. during the thawing process, and the second flowrate range is a constant flowrate of 50 gallons per hour (GPH) to 90 GPH during the thawing process. The combination of maintaining the first temperature range and the second flowrate range of water over the completely submerged one or more food items within the leak-proof package during the thawing process prevents the one or more frozen food items within the leak-proof package from reaching an internal temperature in excess of 40° F.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments herein.

FIG. 1 shows a perspective view of a conventional recirculating water defroster device for thawing frozen food.

FIG. 2 shows a perspective view of a device to facilitate thawing of frozen food items, according to an example embodiment.

FIG. 3 shows a bottom perspective view of the device of FIG. 2.

FIG. 4 shows a top perspective view of the device of FIG. 2.

FIG. 5 shows an exploded parts view of the device of FIG. 2.

FIG. 6 shows a top plan view of the device of FIG. 2 immersed with a sealed food item in a container.

FIG. 7 shows a rear plan view of the container of FIG. 6 with food item and device therein.

FIG. 8 shows a perspective view of a device to facilitate thawing of frozen food items, according to another example embodiment.

FIG. 9 shows a bottom perspective view of the device of FIG. 8.

FIG. 10 shows an exploded parts view of the device of FIG. 8.

FIG. 11 shows a top plan view of the device of FIG. 8 immersed with a sealed food item in a container.

FIG. 12 shows a rear plan view of the container of FIG. 11 with food item and device therein.

FIG. 13 shows a partial exploded parts view to facilitate thawing of frozen food items, according to another example embodiment.

FIG. 14 shows a top plan view of the device of FIG. 13 immersed with a sealed food item in a container.

FIG. 15 shows a rear plan view of the container of FIG. 14 with food item and device therein.

FIG. 16 shows a perspective view to facilitate thawing of frozen food items, according to another example embodiment.

FIG. 17 shows a top plan view of the device of FIG. 16 immersed with a sealed food item in a container.

FIG. 18 shows a rear plan view of the container of FIG. 17 with food item and device therein.

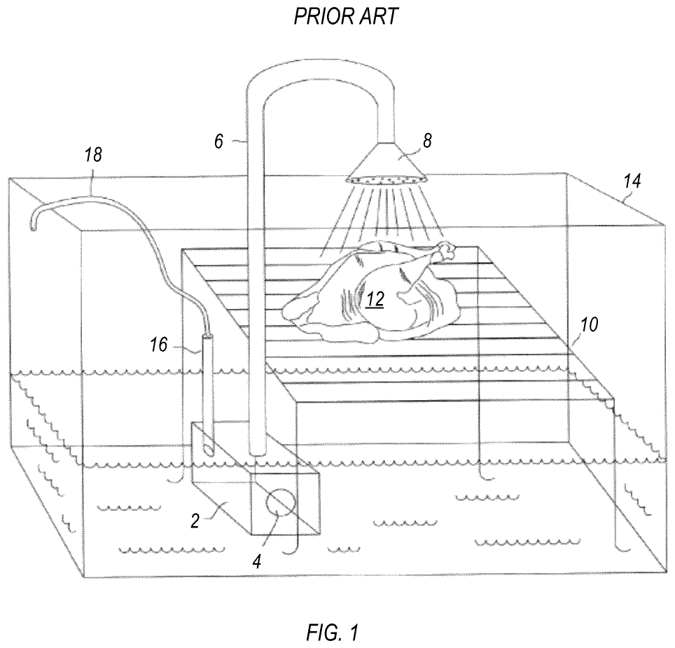

### DETAILED DESCRIPTION

As to be described in detail hereafter, the example embodiments introduce a device to facilitate thawing of frozen food items which is compact in size for ease of use and storage, which is readily usable with various quantities of frozen food items or articles having various dimensions, is efficient in its use of water and consumption of power, and is of a single-container construction capable of being easily sterilized in the event of contamination.

The example device is configured so as to be secured in a useful position for ease of thawing and removal therefrom when thawing is complete. As the drain plug for a kitchen sink can be easily lost and does not always seal well, one example embodiment of the device may incorporate means for plugging a sink basin in conjunction with securing the device to the sink basin or container.

In the following description, certain specific details are set forth in order to provide a thorough understanding of various example embodiments of the disclosure. However, one skilled in the art will understand that the disclosure may be practiced without these specific details. In other instances, well-known structures associated with manufacturing techniques have not been described in detail to avoid unnecessarily obscuring the descriptions of the example embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one example embodiment” or “an embodiment” means that a particular feature, structure or characteristic described in connection with the embodiment is included in at least one embodiment. Thus, the appearances of the phrases “in one example embodiment” or “in an embodiment” in various places throughout this specification are not necessarily all referring to the same embodiment. Further, the particular features, structures or characteristics may be combined in any suitable manner in one or more example embodiments.

As used in this specification and the appended claims, the singular forms “a,” “an,” and “the” include plural referents unless the content clearly dictates otherwise. The term “or” is generally employed in its sense including “and/or” unless the content clearly dictates otherwise.

As used in the specification and appended claims, the terms “correspond,” “corresponds,” and “corresponding” are intended to describe a ratio of or a similarity between referenced objects. The use of “correspond” or one of its forms should not be construed to mean the exact shape or size. In the drawings, identical reference numbers identify similar elements or acts. The size and relative positions of elements in the drawings are not necessarily drawn to scale.

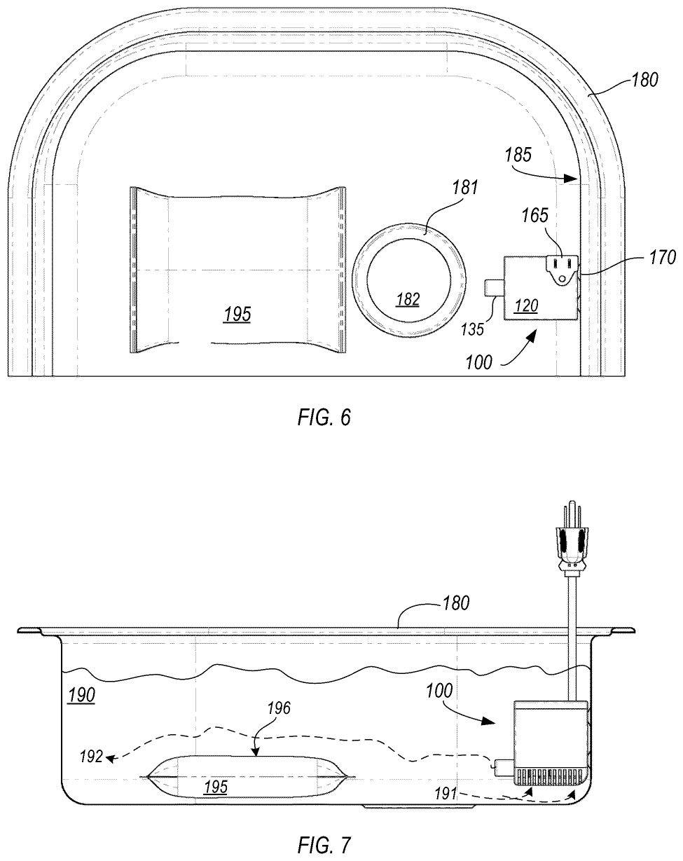

Referring now to FIGS. 2-7, there is shown a device 100 designed to facilitate thawing of one or more frozen food items that are fully submerged within a container such as a sink, bucket, uncovered portable container, and the like. Device 100 includes a housing 110; this housing 110 is adapted for complete immersion in a container 180 (FIGS. 6 and 7) that has a fixed amount of water 190 therein along with full and complete immersion of the one or more frozen food items 195 to be thawed in the water 190. Each food item 195 that is submerged is contained within a leak-proof package 196 or other material bag, plastic bag, wrap, etc. which when enveloping the food item 195 contains minimal or no air therein.

In one instantiation, the example embodiments describe a combination, in which the combination comprises the device 100, the container 180, the device 100 being fully submerged in the container 180, and the fully-submerged food item(s) 195 within its leak-proof package 196 within the container 180. Although container 180 is shown as a kitchen (or bathroom) sink, container 180 may be embodied as any plastic, metal, or glass food container having an opening (uncovered) and adapted to be filled with a volume of water, the device 100 secured and immersed therein.

Housing 110 further comprises an upper cover 120 attached to a housing body 130, and a lower detachable cover 140 attached to a lower end of the housing body 130. Each of the upper cover 120, the housing body 130, and lower cover 140 may be composed of an elastomeric water-resistant synthetic material such as a hard plastic, and/or plastics sealed or coated with various epoxies to prevent contact of fluids or moisture with internal electrical components. The detachable lower cover 140 is connected to the lower end of housing body 130 via a friction fit or tab-lock mechanism (not shown), as is known. By removing the detachable lower cover 140, internals of the device 100, particularly access to elements of a submersible pump 150 sealed within housing body 130, enables easily being able to clean and sanitize the pump 150 elements, coat internal elements with antimicrobial materials, and the like.

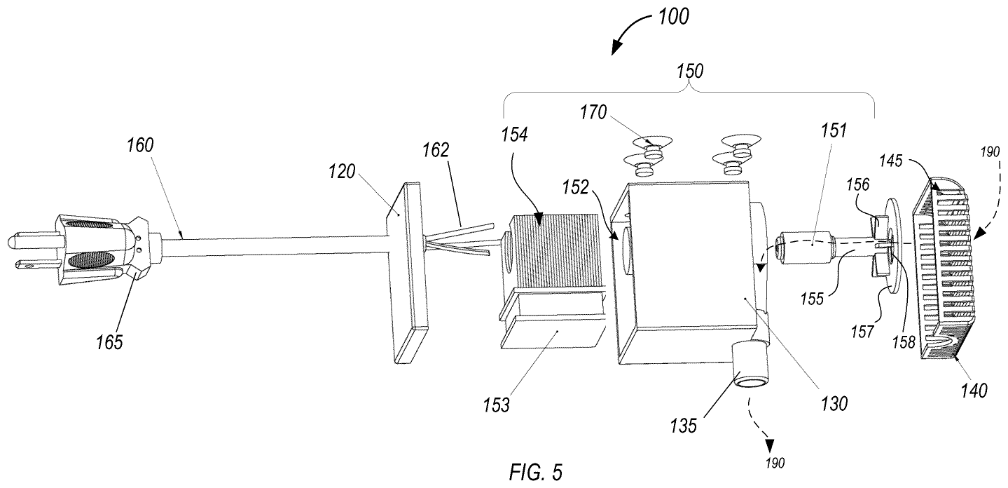

The detachable lower cover 140 includes a plurality of slits 145 in adjacent spaced relation. Slits 145 serve as inlets for the water 190 to be drawn into the pump 150 within the housing body 130, as best shown in FIG. 5. Housing 110 has a securing structure attached thereto for securing the device 100 fixedly in place to a surface 185 of the container 180. In this example embodiment, the securing structure is shown as a plurality of suction cups 170 attached to one of the sides of the housing body 130.

A sealed, waterproof electric submersible pump 150 is provided within the housing body 130. This pump 150 may be a centrifugal-type submersible pump as is known; one example may be a small AC-powered aquaponic or pond pump which can be purchased online or off-the-shelf retail and which generally has a rated flowrate of 100 GPH or less, as a lower flow rate is more than sufficient to facilitate efficient thawing in a container 180 such as a sink. In this example, pump 150 is AC-powered via a cord 160 connected to pump 150 at one end through an aperture in the upper cover 120, the other end of cord 160 terminating in a plug 165 adapted for connection to AC wall power or another AC outlet source. Pump 150 is adapted to agitate water from the container 180 that is drawn in by the pump 150 through the slits 145 of the lower cover 140 into the housing body 130. Device 100 further includes an agitator outlet 135 attached to the housing body 130 for exhausting the water 190 agitated by the pump 150 so as to be circulated at a constant flow rate over the one or more frozen food items 195 within its leak-proof package 196.

As best shown in FIG. 5, the submersible pump 150 essentially comprises a rotor 151 or impeller that rotates within an electrically insulated and waterproof rotor casing 152 for the rotor 151. The rotor 151 contains a magnet (not shown) which attracts to the metal stator vanes 154 of stator 153. This magnetic attraction permits rotor 151 causes rotor 151 to ‘float” in position. The rotor 151 or impeller is essentially a component of a centrifugal pump, and is driven by a motor to increase the pressure and flow of a fluid such as water 190. The rotor 151 in an example may be made of any metal (e.g., iron, steel, bronze, brass, or aluminum), rubber or plastic. The rotor 151 includes a cylinder 155 and rotor vanes 156 at a bottom thereof that overlay an open inlet called an eye 158 of a rotor shroud 157. The rotor vanes 156 push the water 190 radially.

The lower cover 140 with slits 145 sits right up under housing body 130 in contact therewith, covering the exposed rotor shroud 157 of the rotor 151 that sits within its rotor casing 15, and is also in direct contact with agitator outlet 135 due to the small semi-circular cutout located centrally in one of the sides of the lower cover 140. The rotor 151 transfers energy from the motor to the fluid (water 190) being drawn up through the slits 145 and through the eye 158 (which accepts the incoming water 190). The water 190 is pumped to the agitator outlet 135 by accelerating the water 190 outwards from the center of rotation. The velocity achieved by the rotor 151 or impeller transfers into pressure when the outward movement of the water 190 is confined by the rotor casing 152.

The inventor has discovered through research and experimentation that the combination of (a) a modest but constant flow rate of fluid directed over the surface of the fully-submerged food item, coupled with (b) a lower water temperature (a temperature which inhibits growth of bacteria) appears to speed the thawing of food items. As such, and although the example embodiments generally envision a flow rate generated by the pump 150 of less than 100 GPH, it has been shown that a more limited flowrate range, coupled with a lower specific temperature range, is most optimal for food safety, as described later below. Namely, pump 150 generates a flow rate between about 50 to 90 GPH. As to the water temperature, an optimal lower water temperature range, above freezing but less than ambient room temperature to ensure food safety, is maintained between 35° F. to 42° F.

The cold-water temperature range is consistent with governmental guidance which suggests that thawing frozen foods so that the internal temperature of the frozen food remains about 40° F. or less is most optimal for food safety. This critical range of cold-water temperature can be based on the USDA's general guidance on refrigeration, which slows bacterial growth. Namely, bacteria exist everywhere in nature, in the soil, air, water, and the foods we eat. When they have nutrients (food), moisture, and favorable temperatures, they grow rapidly, increasing in numbers to the point where some types of bacteria can cause illness.

Bacteria grow most rapidly in the range of temperatures between 40° F. and 140° F., the “Danger Zone,” some doubling in number in as little as 20 minutes. A refrigerator set at 40° F. or below will protect most foods. As such, a thawing range with water circulation being generated by pump 150 between 50-90 GPH, with water 190 in the container 180 at a cold-water temperature between 35° F. to 42° F. minimizes the bacteria growth threat, so that a frozen food item 195's internal temperature during thaw would never exceed 40° F., optimizing food safety.

To explain the method of operation of thawing frozen food in cold water according to the example embodiments, some of guidance for thawing food in cold water without agitation (e.g., still or standing cold water) as specified by the USDA and FDA should be followed. Namely, the food items 195 must be in the aforementioned leak-proof package 196 (or other material bag, wrap, plastic bag which preferably envelopes the food item 195 with minimal or no air therein. If the bag leaks, bacteria from the air or surrounding environment could be introduced into the food. Also, bagging meat, chicken, and fish tissue as suggested prevents the absorption of water, which may negatively affect taste and texture of the food item, and/or could result in a watery product.

The leak-proof package 196 should be submerged in cold tap water in the desired temperature range (which can be checked by a user simply with a thermometer) as suggested above. With no agitation, the recommendation is that the water 190 in container 180 should be changed every 30 minutes so the food item 195 continues to thaw. However, since the inventor's method of thawing, namely, placing the device 100 in the water submerged at a temperature of 35-42° F., and then powering the device 100 to agitate and circulate water over the food items 195, what usually might take an hour (or less) according to the USDA to thaw small packages of meat, poultry or seafood in standing cold water—about a pound—may be reduced to about 20 minutes or less with the example device 100. Similarly, a 3-to 4-pound package thawing in standing cold water (which the USDA says may take 2 to 3 hours) may be cut in half or more with the device 100.

Water 190 of higher temperature will more quickly impart heat to the frozen items 195 and cause them to thaw more quickly than cold water, though food may be warmed above 40 degrees F. Using the device 100 to circulate water 190 will improve this heat transfer and further reduce time required for thawing, with water 190 of any temperature. By reducing time required to thaw, the device 100 reduces potential exposure time of food items 195 to temperatures in the “Danger Zone”, and thus improves food safety.

Taking into account the above guidance, in operation a frozen food item 195 that has been bagged, preferably in an air-tight fashion to eliminate the potential for bacteria formation on thaw, is placed in container 180, shown as a sink basin in FIGS. 6 and 7. Device 100 is then secured to a surface 185 in container 180; here shown as a sidewall surface. The suction cups 170 hold device 100 secure to the surface 185 of container 180. As container 180 is a sink basin, drain 181 is closed with a suitable plug 182, and container is then filled with a fixed volume of water 190. The plug 165 of device 100 is then connected to an AC source of power (outlet in wall, external source, etc.) to energize pump 150. Intake arrows 191 represent the ingress of water 190 through the inlet slits 145. The ingression of water 190 is agitated within device 100 by pump 150 and outlet 135 then exhausts the water 190 agitated by the pump 150 so as to be circulated (shown by outlet arrow 192) at a constant flow rate over and/or around one or more bagged, frozen food item 195.

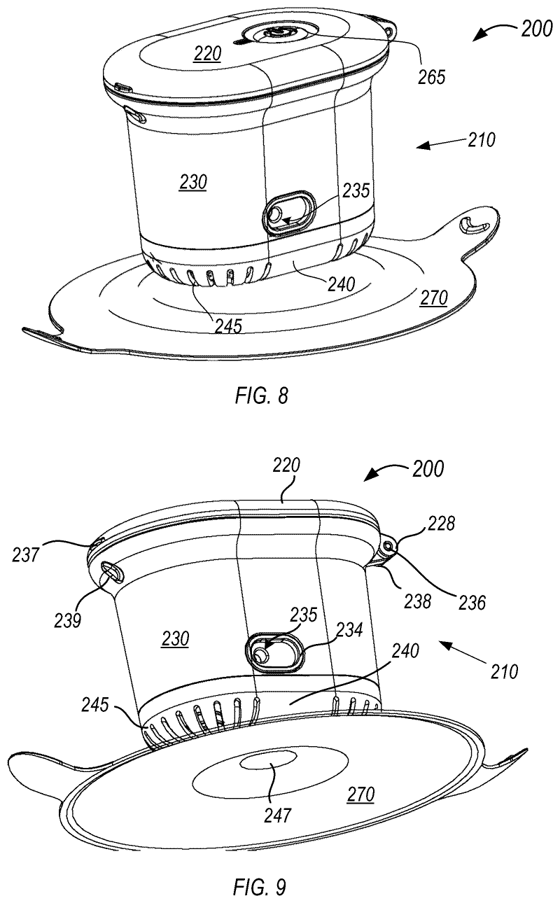

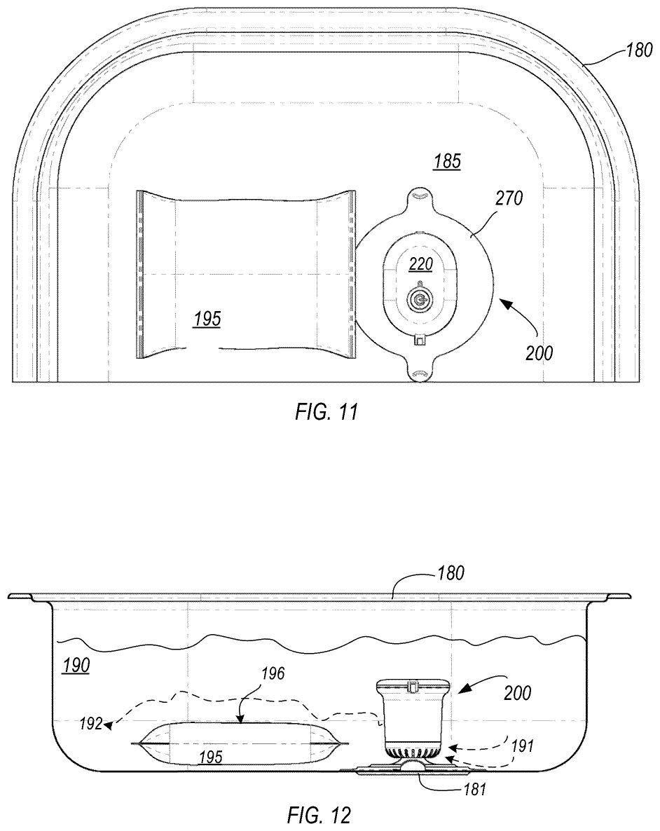

FIGS. 8 through 12 are directed to another example embodiment. In general, device 200 to be described hereafter is similar to device 100 of FIGS. 2 to 7, although it has a slightly different structural makeup as it includes a battery powered DC submersible pump and includes a different securing structure incorporating a dual function.

Referring to FIGS. 8-12, and similar to the previous embodiment, device 200 includes a housing 210 adapted for immersion in a container 180 having a fixed volume of water 190 therein along with full immersion of the one or more frozen food items 195 within its leak-proof package 196 to be thawed in the water 190. Container 180 may be any of a kitchen (or bathroom) sink, or any of a plastic, metal, or glass food container having an opening (uncovered) and adapted to be filled with a fixed amount of water, the device 200 secured and immersed therein.

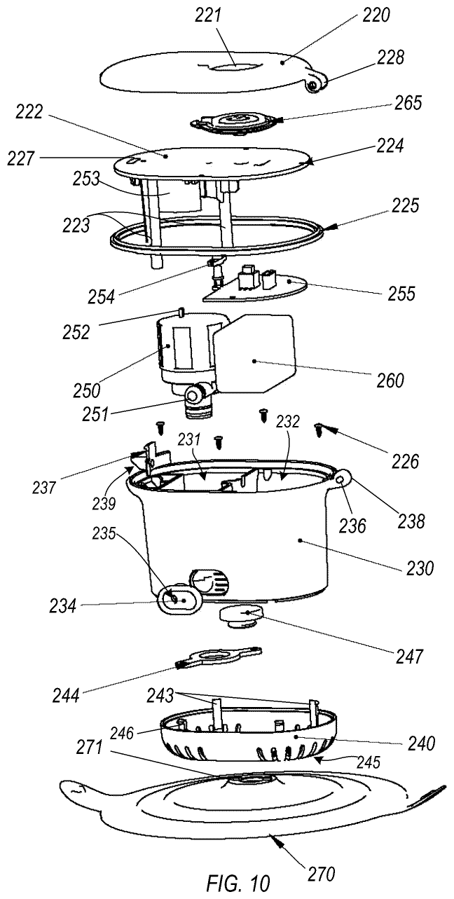

Referring now to FIG. 10, housing 210 includes a detachable upper cover 220 that may be rotatable to be opened by pressing a release 239, which releases a latch 237 (from slot 227) to permit the upper cover 220 to rotate toward an open position via a pivot element (comprised of engaging eyelets 228/238 rotatable about a pivot pin 236). Upper cover 220 may be opened to access a chamber 232 to expose a power jack for recharging a battery 260 therein, or for battery 260 replacement. Housing 210 also includes a hollow housing body 230 and a detachable lower cover 240 attached thereto. Each of the upper cover 220, housing body 230, and lower cover 240 may be composed of an elastomeric water-resistant synthetic material such as a hard plastic, and/or plastics sealed or coated with various epoxies to prevent contact of fluids or moisture with internal electrical components. As with the previous embodiment, the simple construction and detachable covers 220, 240 lends interior access to elements of a pump 250 sealed within housing body 230, so as to clean and sanitize pump 250 elements, coat internal elements with antimicrobial materials, and the like.

A cover plate 222 is sandwiched between the upper cover 220 and a silica gel plate 225, which serves as a gasket between the cover plate 222 and the housing body 230. A series of fasteners 226 (screws) extend through threaded bores 224 in the cover plate 222 connect the cover plate 222 and upper cover 220 to the housing body 230.

An upper portion of the housing body 230 includes the latch 237 and the release 239 which is best shown in FIGS. 9 and 10. The interior of housing body 230 is divided into two chambers 231 and 232. Support beams 223 from the cover plate 222 extend down through these chambers 231, 232 to engage corresponding members 243 extending up from the lower cover 240, thereby sandwiching the housing body 230 therebetween. Latch elements 246 engage recesses (not shown) in the lower part of housing body 230 to secure the lower cover 240 to the housing body 230.

The upper cover 220 includes an opening 221 through which an on/off power button 265 is accessed. The on/off button 265 is electrically connected via a printed circuit board 255 to a DC power supply (the battery 260) which in turn powers a sealed, waterproof submersible DC pump 250 via the PCB 255 and an LGF 254, which is a plastic lens that covers an LED that alights underneath the on/off button 265 when the device 200 is energized on. Battery 260 may be embodied as any of alkaline, lead-acid, coin and aluminum-ion non-chargeable batteries and the like, or rechargeable batteries such as nickel cadmium (NiCd), nickel metal hydride (NiMH), and lithium-ion cells. In an example, PCB 255 may include means to regulate battery 260 charging. The PCB 255 and battery 260 are thus contained in chamber 232; the pump 250 is contained within chamber 231 and is surrounded partly by a sheath 253 extending down from cover plate 222 to retain the pump 250 therein. An axle 252 helps to secure the pump 250 to the underside of cover plate 222 within sheath 253.

The lower cover 240 includes a plurality of slits 245 in adjacent spaced relation, which as before serve as inlets for the water 190 to be drawn into the pump 250 within the housing body 230. Unlike the previous embodiment, the securing structure attached to housing 210 is different and serves multiple purposes. A single broad and wide suction disk 270 is attached to the lower cover 240 via a bearing gasket 244 secured within the lower interior surface of lower cover 240, and a plug 247. The plug 247 extends through a central aperture 271 in disc 270 and through a hole in the bottom of lower cover 240, and is captured by gasket 244 on the interior surface of the lower cover 240 for securing the device 200 to the disc 270. Suction disc 270 contacts a surface 185 of container 180 (such as sink bottom surface) and provides two functions: namely disc 270 serves as a plug for the drain 181 of container 180 so that water 190 may be added to a fixed level, and also due to its suction to surface 185 serves to fixedly secure the device 200 in container 180.

Pump 250 may be a centrifugal-type brushless DC submersible pump as is known; one example may be a small 6V or 12V battery powered DC submersible water pump which can be purchased online or off-the-shelf retail. Alternatively, pump 250 may be powered with a sealed, brushed DC motor. In an example, pump 250 has a rated flowrate of 100 GPH or less, as a lower flow rate is more than sufficient to facilitate thawing in a container 180 such as a sink. Pump 250 agitates the water 190 from the container 180 that is drawn in through the slits 245 of the lower cover 240 into the housing body 230, shown by the intake arrows 191 in FIG. 12. The agitated water 190 is sent through a pump outlet 251 that is aligned with an agitator outlet 235 that is recessed within a bracket 234 provided along an outer side surface of the housing body 230, as shown in FIG. 10. The agitator outlet 235 exhausts the water 190 agitated by the pump 250 so as to be circulated at a constant flow rate (as shown by outlet arrow 192) over and/or around the one or more frozen food items 195 within their leak-proof package 196.

The above example embodiments describe devices 100/200 that accelerate and/or facilitate thawing of frozen food items immersed in a fixed amount of water within a sink basin or other metal, plastic, or glass food container. With the device 100 or 200 immersed in water 190 of a fixed level or amount within a container 180, a submersible pump 150/250 draws the water 190 through the device 100/200 and circulates it through the container 180, efficiently using the water 190 while providing constant circulation over the frozen food items 195 within their leak-proof packages 196. It is envisioned that use of the example devices 100/200 may significantly reduce the time required to thaw frozen foods. As the devices 100/200 are used in a specific range of low-temperature water to optimize food safety (35° F. to 42° F.), the frozen food items 195 may be thawed within their leak-proof packages 196 to a chilled condition while avoiding higher temperatures (such as those typically used in a microwave to defrost) that encourage bacteria growth.

The example devices 100/200 are simple to secure in place within the container 180 for operation, and due to their small size and simple construction with detachable lower cover 140 may be easily cleaned and sterilized if contamination of the device 100 or 200 should occur.

Additionally, a suction disc 270 may be employed with a dual purpose of securing the device in the container (such as a sink, commonly available in food preparation areas and thus easily filled, cleaned, and drained) while also plugging the drain of the sink to permit filling it with the fixed amount of water to immerse the frozen food items and device therein. Further, providing inlets (slits 145/245) in the lower cover 140/240 helps assure that water 190 is always available to the submersible pump 150/250 even where the water level may be low.

However, a series of small suction cups 170 or a broad suction disc 270 are merely two example securing structure configurations; others are contemplated as to be described hereafter. Additionally, in lieu of being powered by a battery 260, the DC centrifugal pump of device 200 may be connected via a cord to an external source of DC power.

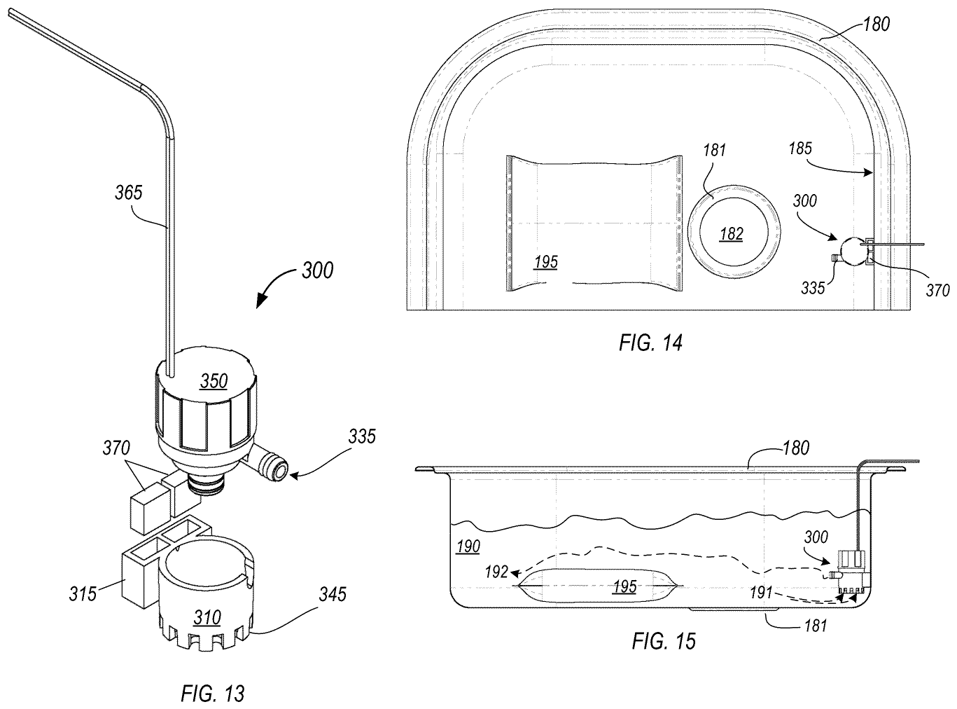

FIG. 13 shows a partial exploded parts view of a device to facilitate thawing of frozen food items, according to another example embodiment; FIG. 14 illustrates a top plan view of the device of FIG. 13 immersed with a sealed food item in a container; and FIG. 15 shows a rear plan view of the container in FIG. 14 with food item and device therein. Referring to FIGS. 13-15, device 300 is similar to devices 100 and 200 in regards to the core components and mode of operation to agitate water 190 so as to create a constant flow rate over a food item 195 within its leak-proof package 196 submerged in a volume of water 190 within container 180. As such, only key differences are discussed in detail for sake of brevity.

Namely, FIG. 13 illustrates a device 300 that is not battery-powered. Rather, device 300 has a sealed, waterproof DC submersible water pump 350 that is connected, via cord 365, to an external source of DC power; thus a corded embodiment of a DC powered device 300. Additionally, the housing structure and securing structure differ as compared to that shown in FIGS. 2-7 or FIGS. 8-12. Pump 350 rests in an open-top housing 310 which includes a plurality of slits 345 at a lower end for water 190 egress. Operation is the same as previously described, in that water 190 sucked up through slits 345 is agitated by pump 350 and exhausted via outlet 335 so as to flow at a constant rate over food item 195. Further, housing 310 include a double-chambered structure 342 integral therewith which is adapted to receive a pair of magnets 370 therein. Thus, in the event the container 180 is formed of a material having magnetic properties, the magnets 370 have such a pull force strength so as to attract the surface 185 of container 180 through the intervening material of the double-chambered structure 342.

In one example, magnets 370 may be comprised of Ferrite. In another, magnets may be Neodymium iron boron magnets (NdFeB, also known as Neo, NIB, rare earth, or super magnets). This magnet is the strongest commercial magnet material currently produced. As magnets typically have poor resistance to corrosion, the magnets would be subject to proper pre-treatment processes and/or application of a plating such as a multi-layer nickel-copper-nickel plating. Alternatively, magnets 370 may be Samarium cobalt (SmCo) magnets, another type of rare earth magnets, which typically are regarded as offering the best value when comparing performance and size in high temperature or adverse environments. In yet another example, magnets 370 may be Alnico magnets, which are largely comprised of aluminum (Al), nickel (Ni), cobalt (Co), aluminum and other trace amounts of elements such as copper (Cu) and titanium (Ti) to tailor the alloy's magnetic and mechanical properties.

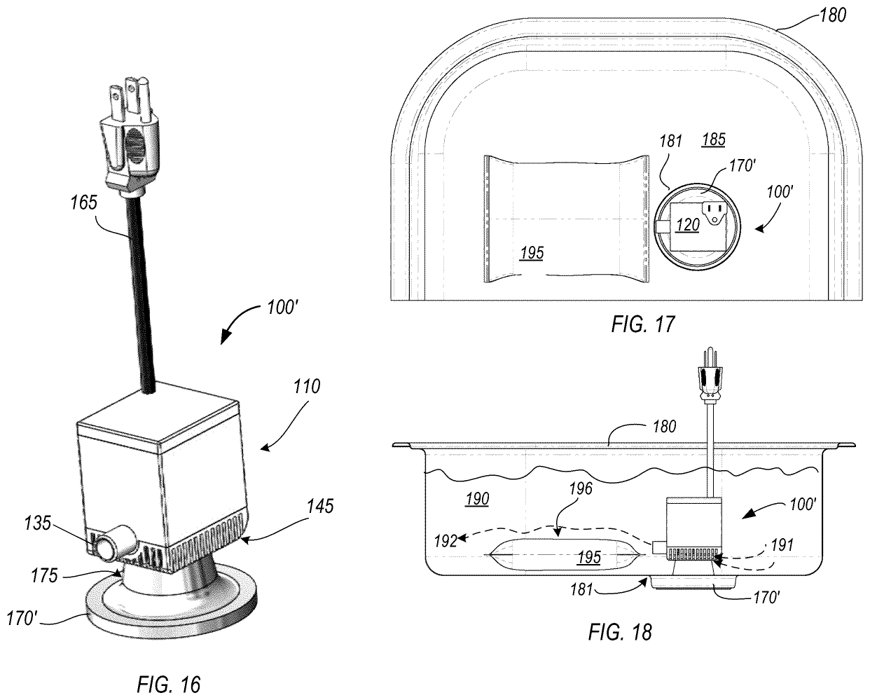

FIG. 16 shows a perspective view of a device to facilitate thawing of frozen food items, according to another example embodiment; FIG. 17 is a top plan view of the device of FIG. 16 immersed with a sealed food item in a container; and FIG. 18 is a rear plan view of the container with food item and device therein. Referring to FIGS. 16-18, there is shown a device 100′ identical to the corded device with AC powered pump 150 shown in FIGS. 2-7. Here, and in lieu of employing small suction cups 170 or a broad suction disc 270 as the securing structure, the securing structure for device 100 is an integral, circular drain plug element 170′ attached to an underside of the housing 110 of device 100′ via a columnar extension or stalk 172, such that the slits 145 remain above the bottom surface 185 of container 180 to enable the ingress of water 190 into housing 110 via the suction of AC pump 150. When installed, the drain plug element 170′ plugs a drain 181 in the container 180 while also securing device 100′ in the container 180.

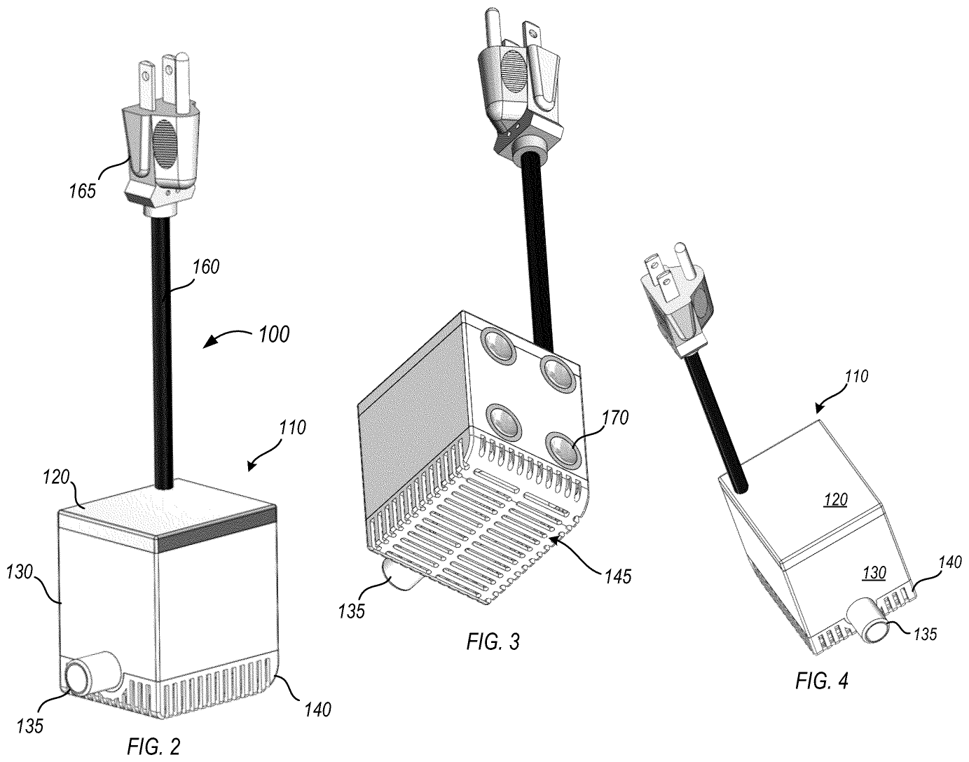

While the example embodiments having been described, it is apparent that such have many varied applications. In an example, the device 100 with the AC submersible pump 150 (see FIG. 3) could have a single suction cup such as is shown for device 200 that could cover the drain, and the device 200 with the DC pump 250 could have one or more smaller suction cups to secure device to a sink surface such as a sidewall. Also, the example embodiments may be applicable but not limited to connection to various devices, structures and articles.

In a further alternative embodiment, the device 100 or 200 may include timing and environmental monitoring means to indicate data such as operating time, water temperature, change in water temperature, temperature of the one or more items being thawed, and the like. As an example, devices 100/200 may incorporate timing and signaling means so that, once activated, the devices 100/200 will operate for an established period of time, and then signal the user visually and/or audibly that a thaw cycle is complete. A limited cycle serves to prevent excess operation and depletion of power. Similarly, where an automated thaw cycle is employed, the devices 100/200 may include water temperature monitoring devices or sensors, signaling the user as water temperature increases, either indicating thawing is completed or that the water temperature has risen to undesirable level.

In yet another alternative example, devices 100/200 could be configured to implement an optional heating function to heat the water it circulates, or could be configured with an optional cooling function that may be implemented to maintain the fixed amount of water at a desired temperature or within a desired range; e.g., to keep water temperature below 42° F., using Peltier thermoelectric or similar devices. The above functions may be implemented in an example by way of electronic communication means, so that instructions (such as initiating a timed operating cycle, and/or transmitting its data for access by an operator or automated remote controller) can be remotely sent to the device.

Additionally, devices 100/200 may also be configured to provide thermostatic temperature control, or to provide temperature indication on the device itself or wirelessly via a sensor communicating temperature information to a user via a smartphone app. Given inputs that include the weight and thickness of the food item and the volume of water used, such an app could estimate when thaw of the food item is complete, based on a detected rise in water temperature.

In another variant, the slits that form the inlet to the pump may include filtering devices or materials, or may include a means to implement centrifugal separation of debris from water being drawn in. In yet another variant, the various structural components of devices 100/200 may include anti-microbial materials, coatings, and the like.

In yet a further variant as applied to the AC-powered embodiment of device 100, water may be routed through the AC coils of the rotor to inhibit growth of water-borne microbes. In yet a further variant as applied to the DC-powered embodiment of device 200, insulated, high voltage DC electrodes may be provided around the water path through the inlet in the bottom to inhibit growth of water-borne microbes. In yet a further variant, a Venturi could be fitted to the agitator outlets to draw in ozone-dense air in order to reduce water-borne microbes.

The present invention, in its various embodiments, configurations, and aspects, includes components, systems and/or apparatuses substantially as depicted and described herein, including various embodiments, sub-combinations, and subsets thereof. Those of skill in the art will understand how to make and use the present invention after understanding the present disclosure. The present invention, in its various embodiments, configurations, and aspects, includes providing devices in the absence of items not depicted and/or described herein or in various embodiments, configurations, or aspects hereof, including in the absence of such items as may have been used in previous devices, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures to those claimed, whether or not such alternate, interchangeable and/or equivalent structures disclosed herein, and without intending to publicly dedicate any patentable subject matter.

I claim:

1. A combination, comprising:
a container at least partially filled with a fixed amount of water maintained in a specified temperature range,
one or more frozen food items contained within a leak-proof package, the leak-proof package with one or more frozen food items completely submerged within the fixed amount of water in the container, and
a device to facilitate thawing the one or more frozen food items in a thawing process in which the device is completely submerged within the fixed amount of water in the container, the device further including:
a housing having a detachable bottom cover at a lower end of the housing, the detachable bottom cover having a flat bottom wall and vertical side walls, with upper ends of the vertical side walls in contact with the lower end of the housing, each of the vertical sidewalls and flat bottom wall of the detachable bottom cover including a plurality of spaced slits for ingress of the water in the container up through the slits in the detachable bottom cover and into the housing interior,
a sealed, waterproof submersible water pump provided within the housing interior and directly accessible via removal of the detachable bottom cover, the submersible water pump adapted to agitate water from the container that is drawn in by the submersible water pump through the slits at a constant flowrate maintained within a specified flowrate range, and
an agitator outlet which remains completely submerged within the fixed amount of water in the container throughout the thawing process, the submerged agitator outlet extending outward from and perpendicular to a vertical side of the housing for exhausting the water agitated by the water pump directly back into the existing fixed amount of water within the container so as to be circulated over the one or more frozen food items within the leak-proof package.

2. The combination of claim 1, wherein the specified temperature range of the fixed amount of water within the container is 35° F. to 42° F. during the thawing process.

3. The combination of claim 1, wherein the submersible water pump maintains the specified constant flowrate of water between 50 gallons per hour (GPH) to 90 GPH during the thawing process.

4. The combination of claim 1, wherein the combination of maintaining the specified range of water temperature and the specified range of constant flowrate of water over the completely submerged one or more food items within the leak-proof package during the thawing process ensures none of the one or more food items within the leak-proof package shall reach an internal temperature in excess of 40° F.

5. The combination of claim 1, wherein the device further includes a securing structure arranged on a surface of the housing for securing the device fixedly in place to a vertical side of the container.

6. The combination of claim 3, wherein the securing structure is selected from a group comprising a plurality of suction cups and a single suction disc adapted to be placed over a drain of a container to secure the device to the container while facilitating filling the container with the fixed amount of water.

7. The combination of claim 1, wherein the submersible water pump is selected from a group comprising an AC-powered submersible water pump and a DC-powered submersible water pump.

8. The combination of claim 1, wherein the submersible water pump is powered via a battery contained in the housing and connected to the pump, or is powered from an external source via a plug with a power cord connected to the pump.

9. The combination of claim 1, wherein the container is any of a kitchen sink, bathroom sink, and a single plastic, metal, or glass food container adapted to be filled with the fixed amount of water.

10. A device to facilitate thawing of one or more frozen food items contained within a leak-proof package that is completely submerged along with the device in a fixed amount of water within a container, the fixed amount of water maintained within a first temperature range during a thawing process and circulated by the device at a constant flowrate within a second flowrate range during the thawing process over the submerged leak-proof package containing the one or more frozen food items, comprising:
a housing having a plurality of slits at a bottom end thereof,
one or more suction elements arranged on a surface of the housing for securing the device fixedly in place to a surface of the container,
a sealed, waterproof submersible water pump provided in the housing and adapted to agitate water from the container that is drawn up through the slits and agitated across an interior bottom surface within the housing, and
an agitator outlet attached to the housing so as to remain completely submerged within the fixed amount of water in the container throughout the thawing process for exhausting the water agitated by the submersible water pump so as to be circulated over the leak-proof package containing the one or more frozen food items, wherein
the first temperature range is 35° F. to 42° F. during the thawing process,
the second flowrate range is a constant flowrate of 50 gallons per hour (GPH) to 90 GPH during the thawing process, and
the combination of maintaining the first temperature range and the second flowrate range of water over the completely submerged one or more food items within the leak-proof package during the thawing process prevents the one or more frozen food items within the leak-proof package from reaching an internal temperature in excess of 40° F.

11. The device of claim 10, wherein the submersible water pump is selected from a group comprising a DC-powered submersible water pump powered via a battery contained in the housing and connected to the pump, and an AC-powered submersible water pump powered from an external source via a plug with a power cord connected to the pump.

12. The device of claim 10, wherein the one or more suction elements is embodied as a plurality of suction cups.

13. A combination, comprising:
a container at least partially filled with a fixed amount of water maintained at a water temperature in a first range,
one or more frozen food items contained within a leak-proof package, the leak-proof package with one or more frozen food items completely submerged within the fixed amount of water in the container, and
a device to facilitate thawing the one or more frozen food items in a thawing process in which the device is completely submerged within the fixed amount of water in the container, the device further including:
a housing having a detachable bottom cover at a lower end of the housing for access to the interior of the housing, and
a sealed, waterproof submersible water pump provided within the housing interior and directly accessible via removal of the detachable bottom cover, the submersible water pump adapted to agitate water from the container that is drawn in by the submersible water pump through the slits at a constant flowrate within a second flowrate range, wherein
the first temperature range is 35° F. to 42° F. during the thawing process,
the second flowrate range is a constant flowrate of 50 gallons per hour (GPH) to 90 GPH during the thawing process, and
the combination of maintaining the first temperature range and the second flowrate range of water over the completely submerged one or more food items within the leak-proof package during the thawing process prevents the one or more frozen food items within the leak-proof package from reaching an internal temperature in excess of 40° F.

14. The combination of claim 13, wherein the submersible water pump is selected from a group comprising an AC-powered submersible water pump and a DC-powered submersible water pump.

15. The combination of claim 13, wherein the submersible water pump is powered via a battery contained in the housing and connected to the pump, or is powered from an external source via a plug with a power cord connected to the pump.

16. The combination of claim 13, wherein the container is any of a kitchen sink, bathroom sink, and a single plastic, metal, or glass food container adapted to be filled with the fixed amount of water.
